(19) United States
(12) Patent Application Publication
(10) Pub. No.: US 2004/0258824 A1
(43) Pub. Date: Dec. 23, 2004

(54) Tofu products tolerant to freezing and process for producing the same

(76) Inventors: Akio Ooi, Kobe-shi (JP); Hiroko Ashida, Tsukuba-gun (JP); Hiroki Oomura, Tsukuba-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/896,966

(22) Filed: Jul. 23, 2004

Related U.S. Application Data
(63) Continuation-in-part of application No. PCT/JP02/13262, filed on Dec. 18, 2002.

(30) Foreign Application Priority Data
Feb. 4, 2002 (JP) 2002-27421
Jul. 11, 2002 (JP) 2002-203107

(51) Int. Cl. A23G 1/00

(52) U.S. Cl. 426/573

(57) ABSTRACT

A process for producing a tofu product which comprises adding native gellan gum and modified starch to soybean milk at a high temperature, then adding a coagulating agent thereto for coagulation, heating and sterilizing the tofu product and freezing it.

### TECHNICAL FIELD

The present invention relates to a process for producing a tofu (soybean curd) product tolerant to freezing.

### BACKGROUND ART

It has been well known that, when frozen tofu is thawed, its texture becomes porous due to freezing denaturation to show a dried-frozen tofu state. Heretofore, attempts have been made to prevent this freezing denaturation. For example, in JP 9-313125 A, improvement in freezing denaturation of tofu has been tried by using modified starch and gelatin.

However, in any of such attempts, only physical properties of tofu such as presence or absence of freeze resistance after freezing are considered, and no mouthfeel suitable for tofu is pursued. Further, although JP 10-304839 A discloses improvement in mouthfeel and thermal resistance with respect to a process for producing a noodle-type tofu product by using gelatinizing agents including gellan gum, no effect on freeze resistance is investigated. In addition, when only such a gelatinizing agent is used for a frozen tofu product, the effect on freeze resistance is insufficient. Furthermore, generally called gellan gum is that obtained by subjecting naturally occurring gellan gum to deacylation, and this provides poor freeze resistance and much syneresis in comparison with native type gellan gum, i.e., native gellan gum which is not subjected to deacylation. Moreover, since generally called gellan gum forms a hard gel, it is unsuitable for using in tofu from the viewpoint of mouthfeel.

JP 10-99040 A and JP 5-316984 A discloses processes for producing frozen tofu products using gelatinizing agents. However, native gellan gum is not referred to in these prior art, and gelatinizing agents other than native gellan gum are used. Then, the mouthfeel of the resultant products is insufficient from the viewpoint of mouthfeel similar to tofu.

The problem to be solved by the present invention is to provide a process for producing a tofu product tolerant to freezing.

### DISCLOSURE OF THE INVENTION

The present invention relates to a tofu product comprising native gellan gum and modified starch. The tofu product of the present invention includes not only tofu but also “atsuage (deep-fried tofu)” obtained by frying tofu. For preventing freezing denaturation of a tofu product, addition of modified starch having freeze resistance is effective. However, in order to exhibit the effect of its addition, the amount of modified starch to be added should be 2.5% by weight or more based on soybean milk and, when its amount is too much, the mouthfeel is adversely influenced. Then, the amount of modified starch to be added should be reduced so that the mouthfeel is not adversely influenced. However, when the amount of modified starch to be added is reduced, the prevention of freezing denaturation is hardly accomplished. Then, as a substitute therefor, it is necessary to add a different additive which is effective for imparting freeze resistance. Among such additives, native gellan gum is found to be most suitable for providing mouthfeel similar to tofu with a minimum amount thereof. As a result, it has been found that a frozen tofu product having mouthfeel similar to tofu can be obtained with preventing freezing denaturation by minimizing an amount of modified starch to be added and using an appropriate amount of native gellan gum. Thus, the present invention has been completed.

That is, the present invention is a process for producing a tofu product having freeze resistance, which is obtained by adding native gellan gum and modified starch to soybean milk heated at a gelation temperature of native gellan gum or higher, i.e., 60° C. or higher, then adding a coagulating agent thereto for coagulation, heating the resultant product and freezing it. At this time, preferably, native gellan gum is added to the soybean milk in an amount of 0.01 to 0.1% by weight based on the soybean milk, and modified starch is added to the soybean milk in an amount of 0.5 to 2.0% by weight based on the soybean milk.

### BEST MODE FOR CARRYING OUT THE INVENTION

In the present invention, any soybean milk can be used in so far as tofu can be produced therefrom. After adjusting the temperature of soybean milk to a gelation temperature of native gellan gum or higher, native gellan gum and modified starch are added, and then a coagulating agent is added, followed by heat-sterilization.

For producing soybean milk, soaked soybeans are ground with addition of water to prepare slurry and “okara (soy pulp)” is separated to obtain soybean milk. Soybean milk is condensed so that the solid content of soybean milk becomes preferably 10 to 18% by weight.

To the condensed soybean milk thus produced are added modified starch and native gellan gum so as to prevent freezing denaturation. Optionally, a saccharide may be added in order to assist these materials to impart freeze resistance. Preferred examples of the saccharide to be used include those having low sweetness such as oligosaccharides, sugar alcohols, trehalose, and the like.

Native gellan gum used in the present invention is a polysaccharide which is produced by a microorganism and does not undergo deacylation during its production steps. Among gellan gums, native gellan gum which does not undergo deacylation is effective for preventing syneresis and imparting freeze resistance. On the other hand, a gel of gellan gum which undergoes deacylation is broken upon freezing.

The modified starch used in the present invention includes cross-linked starch, α-starch, oxidized starch etherified starch, and the like, which are made from potato starch, tapioca starch, wheat flour starch, waxy corn starch, corn starch, and the like. Preferably, modified starch having freeze resistance is used.

The amount of native gellan gum to be added is 0.01 to 0.1% by weight, preferably 0.02 to 0.05% by weight. When the amount is smaller than 0.01% by weight, freezing denaturation is caused. On the other hand, when the amount is 0.1% by weight, a weak gel of tofu is formed and the mouthfeel comes out gooey.

The amount of modified starch to be added is 0.5 to 2.0% by weight, preferably 0.8 to 1.5% by weight. When the amount is smaller than 0.5% by weight, freezing denaturation is caused. On the other hand, when the amount is larger than 2.0% by weight, the mouthfeel comes out dry and tasteless.

In the production of the tofu product of the present invention, native gellan gum and modified starch are added to soybean milk at a high temperature, followed by addition of a coagulating agent to perform a coagulation reaction. By using native gellan gum previously dispersed and dissolved in water, it can be readily and uniformly mixed with soybean milk. Preferably, a solution of native gellan gum heated to 80° C. or higher is used. The temperature of soybean milk to be used is adjusted by heating at a gelation temperature of native gellan gum or higher, i.e., 60 to 90° C., preferably, 70 to 80° C. When the temperature of soybean milk upon mixing is lower than 60° C., the coagulation reaction is delayed, starch is deposited and native gellan gum cannot be fully dissolved in soybean milk, which results in uneven tofu texture and an inferior tofu product. On the other hand, when the temperature of soybean milk is higher than 90° C., soybean milk is severely damaged by heating and further the coagulation reaction proceeds very quickly, which results in an inferior tofu gel. The heat-sterilization after the coagulation reaction is performed at 80 to 95° C., preferably 85 to 95° C. When the temperature is lower than 80° C., sterilization is insufficient. On the other hand, when the temperature is higher than 95° C., the tofu product is spongy. The tofu product thus obtained is frozen by quick freezing to obtain the frozen tofu product. The quick freezing is performed at −20 to −50° C., preferably −30 to −40° C. The frozen tofu product thus obtained has freeze resistance and, even after thawing, it has smooth mouthfeel.

The tofu product obtained can be fried to obtain “atsuage∞. The frying is performed at 150 to 190° C., preferably 160 to 180° C. The “atsuage” thus, obtained is frozen by quick freezing to product frozen “atsuage”. The quick freezing is performed at −20 to −50° C., preferably −30 to −40° C. The resultant frozen “atsuage” has freeze resistance and, even after thawing, it has smooth mouthfeel. Further, depending upon frying conditions, thick skin of “atsuage” can be formed and, upon cooking with soup, the soup deeply soaks into the product.

### EXAMPLES

The present invention will be further illustrated in detail by the following Examples.

### Example 1

To 5 kg of whole soybeans was added 15 kg of water (20° C.), and soybeans were soaked in water for 14 hours. The soybeans were separated into soaked whey and soaked soybeans with a 10 mesh sieve. Then, the soaked soybeans were ground together with 25 kg of water for grinding (20° C.) by using a grinder (manufactured by Nakazawa Kikai Seisakusho) to obtain slurry. The slurry was separated into soybean milk (solid concentration: 9% by weight) and “okara” by using: a separator (manufactured by K. K. Tofer). The soybean milk was subjected to heat treatment at 98° C. for 5 minutes by using an indirect heating apparatus (manufactured by K. K. Seiko). The soybean milk obtained was condensed under reduced pressure of 100 torr with a condenser (manufactured by K. K. Hisaka Seisakusho) to adjust to a solid content of 13% by weight.

Then, to the condensed soybean milk which was adjusted to 75° C. (100 parts by weight) were added 1 part by weight of crosslinked-etherified waxy corn starch (“Pine Ace” manufactured by Matsutani Kagaku K. K., the same starch was used hereinafter) and 0.03 part by weight of native gellan gum [Kelcogel LT-100 manufactured by Sanei-Gen FFI K. K., the same native gellan gum was used hereinafter (10 parts by weight of 0.3% native gellan gum solution completely dissolved at 80° C. was added to the soybean milk.)]. Then, 0.4 part by weight of calcium sulfate was added to the mixture. The coagulation temperature was 70° C. After coagulation, the resultant product was steamed at 90° C. for 40 minutes. After cooling to 20° C. or lower, the produce was subjected to quick freezing in an atmosphere at about −35° C.

### Example 2

According to the same manner as that described in Example 1, a tofu product was produced except that condensed soybean milk adjusted to 85° C. was used, the amount of native gellan gum to be added was 0.05 part by weight (10 parts by weight of 0.5% native gellan gum solution was added to soybean milk) and the coagulation temperature was 80° C.

### Example 3

According to the same manner as that described in Example 1, a tofu product before freezing was produced except that the solid content of soybean milk was 16% by weight. The tofu product was fried with rapeseed oil at 190° C. for 2 minutes and then subjected to quick freezing in an atmosphere at about −35° C.

### Example 4

According to the same manner as that described in Example 2, a tofu product before freezing was produced except that the solid content of soybean milk was 16% by weight. The tofu product was fried with rapeseed oil at 180° C. for 2 minutes and then subjected to quick freezing in an atmosphere at about −35° C.

### Comparative Example 1

According to the same manner as that described in Example 1, a tofu product was produced except that condensed soybean milk adjusted at 50° C. was used and the coagulation temperature was 50° C.

### Comparative Example 2

According to the same manner as that described in Example 1, a tofu product was produced except that the amount of native gellan gum to be added was 0.005 part by weight (10 parts by weight of 0.05% solution o.f native. gellan gum was added to soybean milk).

### Comparative Example 3

According to the same manner as that described in Example 1, a tofu product was produced except that the amount of native gellan gum to be added was 0.2 part by weight (10 parts by weight of 2.0% solution of native gellan gum was added to soybean milk).

### Comparative Example 4

According to the same manner as that described in the above Example, a tofu product was produced except that the amount of modified starch to be added was 0.1 part by weight.

### Comparative Example 5

According to the same manner as that described in the above Example, a tofu product was produced except that the amount of modified starch to be added was 3.0 parts by weight.

### Comparative Example 6

According to the same manner as that described in Comparative Example 1, a tofu product before freezing was produced except that the solid content of soybean milk was 16% by weight. The tofu product was fried with rapeseed oil at 190° C. for 2 minutes to produce “atsuage” and then subjected to quick freezing in an atmosphere at about −35° C.

### Comparative Example 7

According to the same manner as that described in Comparative Example 2, a tofu product before freezing was produced except that the solid content of soybean milk was 16% by weight. The tofu product was fried with rapeseed oil at 180° C. for 2 minutes to produce “atsuage” and then subjected to quick freezing in an atmosphere at about −35° C.

### Method for Evaluating Quality

Mouthfeel was organoleptically evaluated after thawing the frozen tofu or “atsuage” at room temperature. A product having smooth and tofu-like mouthfeel was scored 5 and a product being gooey due to addition of starch was scored 1.

Regarding freeze resistance, a product without a spongy state was scored 5 and a product having a spongy state was scored 1.

Regarding a skin thickness of “atsuage”, a product having thick and “atsuage”-like skin was scored 5 and a product having thin skin was scored 1.

Further, regarding soaking of soup into a product, the product was cooked with Japanese-style soup at 90° C. for 20 minutes and then organoleptically evaluated. A product wherein the soup most deeply soaked thereinto was scored 5 and a product wherein the soup scarcely soaked thereinto was scored 1.

The overall evaluation was expressed by the average score of mouthfeel, freeze resistance, fried skin and soaking of soup.

TABLE
Results of quality evaluation

| | |
|---|---|
| Evaluation | Examples |

| items | 1 | 2 | 3 | 4 |
|---|---|---|---|---|
| Mouthfeel | 5 | 4 | 5 | 4 |
| Freeze | 5 | 5 | 5 | 5 |
| resistance | | | | |
| Fried skin | — | — | 5 | 5 |
| Soaking of | — | — | 5 | 5 |
| soup | | | | |
| Overall | 5 | 5 | 5 | 5 |
| evaluation | | | | |

| Evaluation | Comparative Examples | | | | | | |
|---|---|---|---|---|---|---|---|
| items | 1 | 2 | 3 | 4 | 5 | 6 | 7 |
| Mouthfeel | 2 | 2 | 2 | 3 | 1 | 2 | 2 |
| Freeze | 2 | 2 | 4 | 2 | 5 | 2 | 2 |
| resistance | | | | | | | |
| Fried skin | — | — | — | — | — | 2 | 2 |
| Soaking of | — | — | — | — | — | 2 | 2 |
| soup | | | | | | | |
| Overall | 2 | 2 | 3 | 3 | 3 | 2 | 2 |
| evaluation | | | | | | | |

The evaluation was performed by 5 panelists according to the above 5-rank scoring. The score of 4 or more is good.

In the products of Examples 1, 2, 3 and 4, firm tofu gels were formed with less syneresis and the products had freeze resistance and most tofu-like mouthfeel. Further, in case of “atsuage”, there were such advantages that thick fried skin was formed and soaking of soup was good in addition to mouthfeel and freeze resistance.

In the products of Comparative Examples 1 and 6, gels were uneven and good tofu products were hardly obtained. Although Comparative Example was not shown, when using soybean milk at a temperature of 10° C. lower than those in the Comparative Examples, the resultant tofu product was worse than them. In Comparative Examples 2, 4 and 7, freezing denaturation occurred, which resulted in conventional dried-frozen tofu (“koya-dofu”)-like mouthfeel. In Comparative Examples 3 and 5, mouthfeel was deteriorated. Further, although Comparative Example was not shown, when using deacylated gellan gum instead of native gellan gum, the resultant tofu product had no freeze resistance, much syneresis and hard mouthfeel, and its mouthfeel was far from that of tofu and undesirable.

### Industrial Applicability

According to the present invention, a tofu product tolerant to freezing can be produced industrially.

1. A tofu product comprising native gellan gum and modified starch:

2. A process for producing a frozen tofu product which comprises adding native gellan gum and modified starch to soybean milk at a high temperature, then adding a coagulating agent thereto for coagulation, heating the resultant product and freezing it.

3. The process according to claim 2, wherein the temperature of soybean milk is the gelation temperature of native gellan gum or higher.

4. The process according to claim 2, wherein native gellan gum is added to the soybean milk in an amount of 0.01 to 0.1% by weight based on the soybean milk.

5. The process according to claim 2, wherein modified starch is added to the soybean milk in an amount of 0.5 to 2.0% by weight based on the soybean milk.

6. The process according to claim 3, wherein native gellan gum is added to the soybean milk in an amount of 0.01 to 0.1% by weight based on the soybean milk.

7. The process according to claim 3, wherein modified starch is added to the soybean milk in an amount of 0.5 to 2.0% by weight based on the soybean milk.

8. The process according to claim 4, wherein modified starch is added to the soybean milk in an amount of 0.5 to 2.0% by weight based on the soybean milk.

9. The process according to claim 6, wherein modified starch is added to the soybean milk in an amount of 0.5 to 2.0% by weight based on the soybean milk.
